(19) United States
(12) Patent Application Publication
(10) Pub. No.: US 2021/0074065 A1
(43) Pub. Date: Mar. 11, 2021

(54) INTERACTIVE AUGMENTED REALITY IMAGE CAPTURING SYSTEM

(71) Applicant: SPEED 3D Inc., Taipei City (TW)

(72) Inventors: Li-Chuan Chiu, Taipei City (TW); Jui-Chun Chung, Taipei City (TW); Hui-Chun Chen, Taipei City (TW); Yi-Ping Cheng, Taipei City (TW)

(21) Appl. No.: 16/737,865

(22) Filed: Jan. 8, 2020

(30) Foreign Application Priority Data
Sep. 6, 2019 (CN) 201910844268.6

(51) Int. Cl. G06T 19/00; G06F 3/01; H04N 5/225

(52) U.S. Cl. CPC G06T 19/006; H04N 5/2256; G06F 3/011

(57) ABSTRACT

An interactive augmented reality image capturing system, and the system includes a management module, an operation module, a display module, and an image capturing module. The management module includes a control unit and a storage unit. The storage unit stores a virtual scenario and a virtual object. The operation module is adapted to retrieve the virtual scenario and the virtual object. The image capturing module includes a sensing unit. The video recording unit captures a dynamic image of a user. The sensing unit detects three-dimensional information of the user and transmits the three-dimensional dynamic information to the management module. The management module receives the three-dimensional dynamic information and applies the virtual scenario and the virtual object on the dynamic image to generate a dynamic virtual image. The management module requests the display module to display the dynamic virtual image. The management module further stores the dynamic virtual image.

### BACKGROUND OF THE INVENTION

### 1. Field of the Invention

The present invention relates to an interactive augmented reality image capturing system, in particular to an interactive video system with virtual scenario and object applications, so that a user can have a captured image modified by the virtual scenario and object.

### 2. Description of the Prior Art

Image capturing machines are popular, and the most popular machine is the photo-sticker booth. The booths have drawing and filtering effects to beautify the photo, so that you people are addicted in having fun with the booths. The booths are disclosed, for example, in Taiwan Patent number M521215, M513425, and M434274.

However, the abovementioned booths or capturing machines are available to provide planar image effects. Even if the booths or machines can provide three-dimensional images, these images are stationary and cannot satisfy user's requirements. The user cannot interact with the booths or machines, thereby resulting in a limited effect for the provided image.

In view of these, it is an issue of the present invention to design a video system which is easy to operate, interactive with users, capable of providing entertainment during operation, and user satisfied.

### SUMMARY OF THE INVENTION

In view of these, an embodiment of the present invention provides an interactive augmented reality image capturing system, and the system comprises a management module, an operation module, a display module, and an image capturing module.

The management module comprises a control unit and a storage unit. The storage unit stores at least one virtual scenario, at least one virtual object, or both the at least one virtual scenario and the at least one virtual object. The operation module is electrically connected to the management module. The operation module is adapted to be operated by a user, so that the user is adapted to retrieve the at least one virtual scenario, the at least one virtual object, or both the at least one virtual scenario and the at least one virtual object. The display module is electrically connected to the management module. The image capturing module is electrically connected to the management module. The image capturing module comprises a sensing unit. The video recording unit captures a dynamic image of the user. The sensing unit detects three-dimensional information of the user and transmits the three-dimensional dynamic information to the management module.

Wherein the management module receives the three-dimensional dynamic information and applies the at least one virtual scenario, the at least one virtual object, or both the at least one virtual scenario and the at least one virtual object on the dynamic image of the user to generate a dynamic virtual image. The management module requests the display module to display the dynamic virtual image. The management module further stores the dynamic virtual image.

In one embodiment, the system further comprises an image output module electrically connected to the management module. The user is adapted to operate the operation module to transmit an output command to the management module so as to make the image output module output the dynamic virtual image.

In one embodiment, the image output module outputs the dynamic virtual image as a photo, a puzzle, a postcard, a sticker, or a combination thereof.

In one embodiment, the system further comprises a light module electrically connected to the management module for adjusting a light effect when the video recording unit captures the dynamic image of the user.

In one embodiment, the system further comprises a transmission module. A storage device of the user is adapted to be signally connected to the transmission module to receive the dynamic virtual image.

In one embodiment, the system further comprises a cloud server adapted to receive the dynamic virtual image transmitted by the management module.

In one embodiment, the management module further requests the display module to display a link code, and a scan device of the user is adapted to scan the link code to download the dynamic virtual image from the cloud server.

In one embodiment, the system further comprises a charge module electrically connected to the management module. The charge module is adapted to make payment receipt, so that the user is allowed to operate the operation module. The payment receipt is made with physical money or virtual money.

In one embodiment, the management module further stores a plurality of multimedia images, and the management module request the display module to display the multimedia images in an idle state.

In one embodiment, the system further comprises an image adjustment module electrically connected to the management module. The user is adapted to operate the operation module so as to allow the management module to request the image adjustment module to adjust an image effect of the at least one virtual scenario, an image effect of the at least one virtual object, or both the image effect of the at least one virtual scenario and the image effect of the at least one virtual object.

In one embodiment, the system further comprises a computation module electrically connected to the management module. The computation module is adapted to count physiological information of the user, a usage rate of the at least one virtual scenario, a usage rate of the at least one virtual object, or a combination thereof to generate statistics data, and the computation module is adapted to transmit the statistics data to the management module.

Based on the interactive augmented reality image capturing system according to one or some embodiments of the present invention, the user can have more virtual entertainments and more user-machine interaction experiences. According to user's personal preference, the user can wear the virtual object on the image or can interact with the virtual object, and the image can be outputted. As compared with the known image capturing system which is stationary and monotone, the interactive augmented reality image capturing system according to one or some embodiments of the present invention can be utilized widely and has a great commercial value.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a perspective view of an interactive augmented reality image capturing system according to one embodiment of the present invention;

FIG. 2 illustrates a schematic block diagram (1) of the interactive augmented reality image capturing system according to one embodiment of the present invention;

FIG. 3 illustrates a schematic block diagram (2) of the interactive augmented reality image capturing system according to one embodiment of the present invention;

FIG. 4 illustrates a schematic block diagram (3) of the interactive augmented reality image capturing system according to one embodiment of the present invention;

FIG. 5 illustrates a schematic operational view (1) of the interactive augmented reality image capturing system according to one embodiment of the present invention;

FIG. 6 illustrates a schematic operational view (2) of the interactive augmented reality image capturing system according to one embodiment of the present invention;

FIG. 7 illustrates a schematic operational view (3) of the interactive augmented reality image capturing system according to one embodiment of the present invention;

FIG. 8 illustrates a schematic operational view (4) of the interactive augmented reality image capturing system according to one embodiment of the present invention; and

FIG. 9 illustrates a schematic operational view (5) of the interactive augmented reality image capturing system according to one embodiment of the present invention.

### DETAILED DESCRIPTION

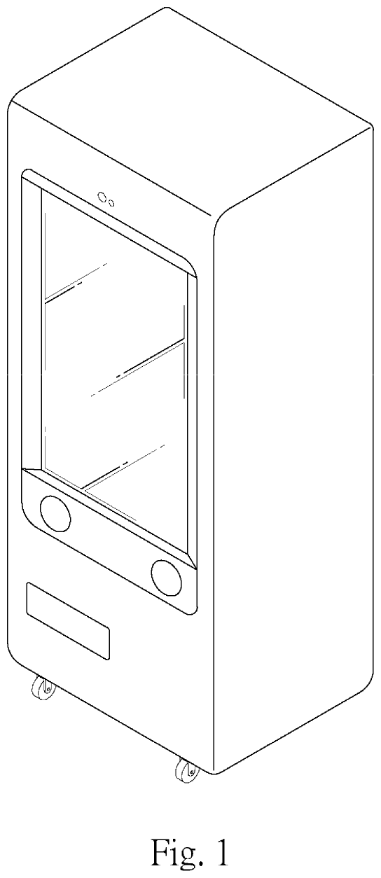

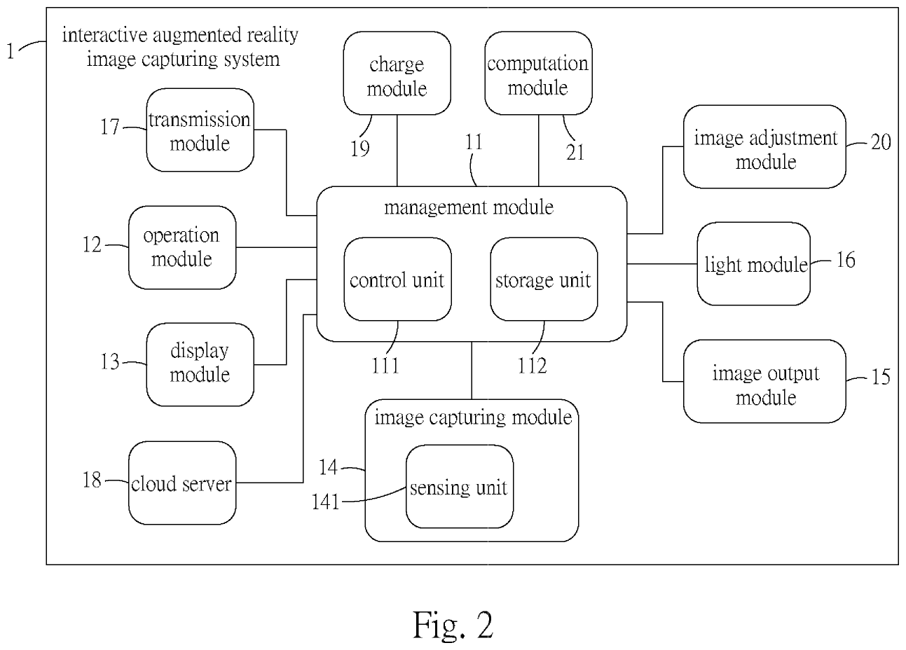

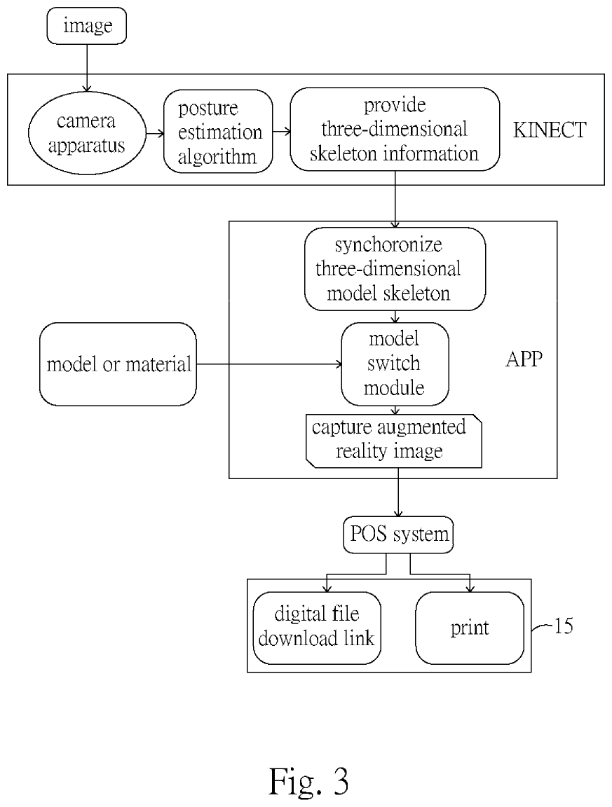

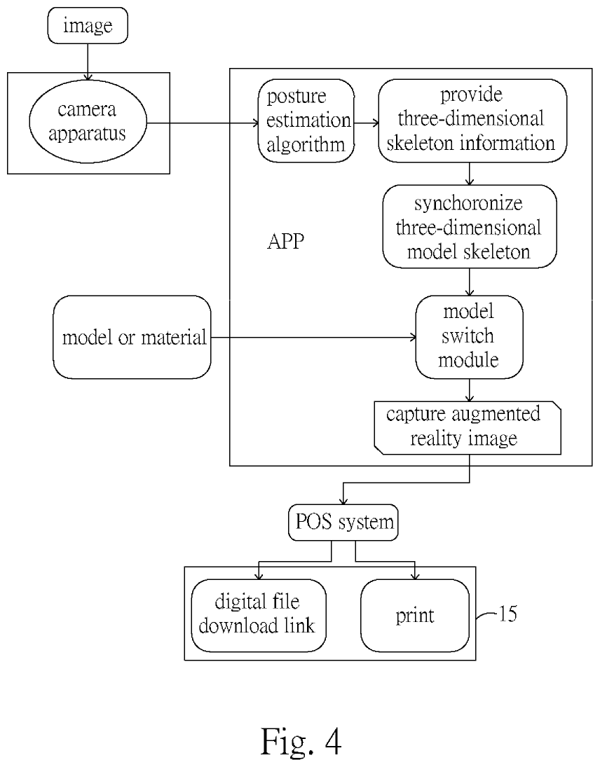

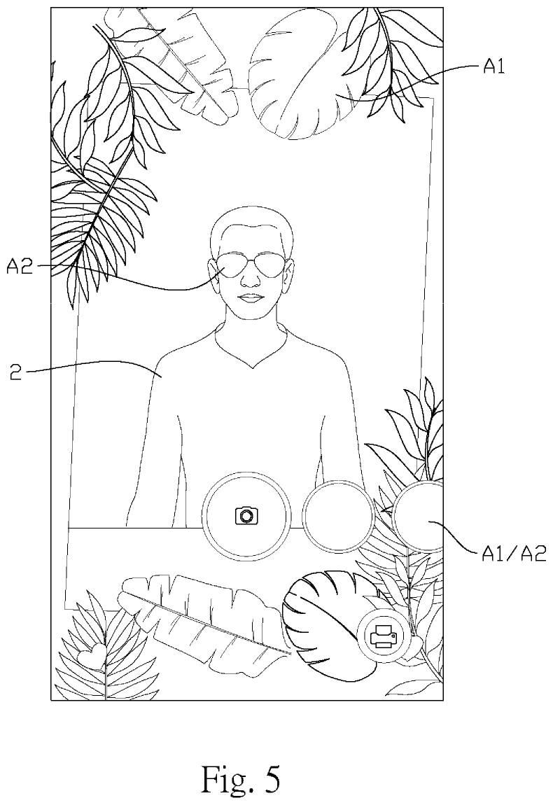

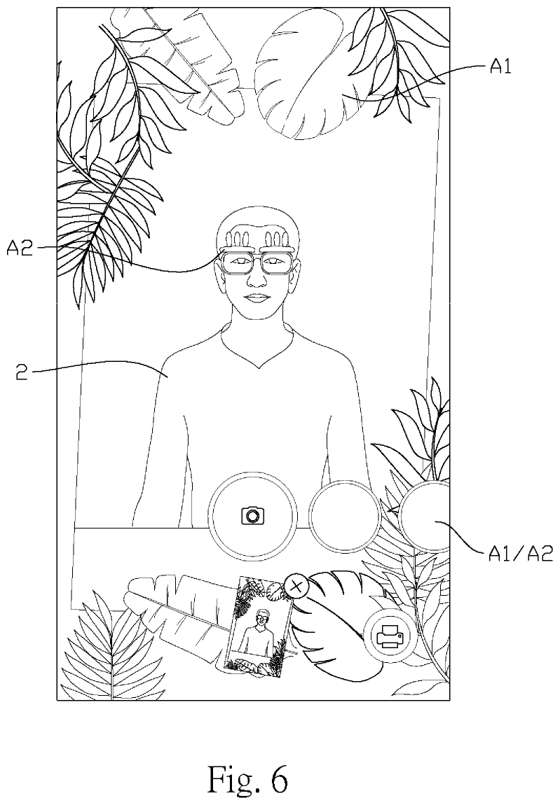

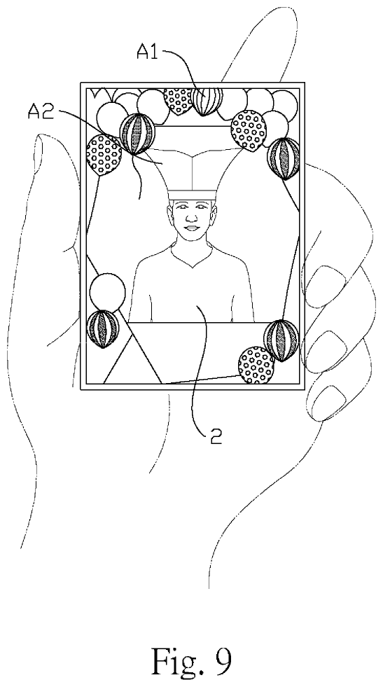

Please refer to FIGS. 1 to 4, respectively illustrate a perspective view and schematic block diagrams of an interactive augmented reality image capturing system according one embodiment of the present invention. Please further refer to FIGS. 5 to 9, respectively illustrate schematic operational views of the interactive augmented reality image capturing system according to one embodiment of the present invention.

The interactive augmented reality image capturing system (hereinafter, system 1) comprises a management module 11, an operation module 12, a display module 13, and an image capturing module 14. The system 1 may be implemented as a machine, and the machine can be provided at exhibition halls, airports, or other public places. The machine may have a screen to display images or videos and may have an apparatus for printing the images.

The management module 11 comprises a control unit 111 and a storage unit 112. The storage unit 112 stores at least one virtual scenario A1, at least one virtual object A2, or both the at least one virtual scenario A1 and the at least one virtual object A2.

The virtual scenario A1 may be a scene or a filter effect, for example, the scene may be ocean, outer space, grassland, amusement park; the filter effect may be an antique photo frame.

The virtual object A2 may be equipment, such as sunglasses, wig, armor, or pet, so that the equipment may interact with the user 2. Moreover, the system 1 further comprises an image adjustment module 20, so that the image adjustment module 20 can adjust the image effect of the virtual scenario A1 or the image effect of the virtual object A2. Hence, the adjusted image or video can be more beautiful.

The operation module 12 is electrically connected to the management module 11, and the operation module 12 is adapted to be operated by the user 2, so that the user 2 is adapted to retrieve the virtual scenario A1, the virtual object A2, or both the virtual scenario A1 and the virtual object A2. The display module 13 is electrically connected to the management module 11. In this embodiment, the display module 13 and the operation module 12 are integrated as, for example, a touch screen.

The image capturing module 14 is electrically connected to the management module 11. The image capturing module 14 comprises a sensing unit 141. The image capturing unit 14 captures a dynamic image of the user 2. The sensing unit 141 detects three-dimensional dynamic information of the user 2 and transmits the three-dimensional dynamic information to the management module 1.

In some embodiments, the image capturing module 14 performs the posture estimation algorithm to the dynamic image of the user 2, and the image capturing module 14 provides three-dimensional skeleton information of the dynamic image of the user to the management module 11. The management module 11 combines the three-dimensional skeleton information with the virtual scenario A and the virtual object A2, so that the virtual scenario A1 and the virtual object A2 are applied on the dynamic image of the user 2, and a dynamic virtual image can be generated. The display module 13 displays the dynamic virtual image. In one embodiment, the management module 11 further stores the dynamic virtual image.

In some embodiments, when the image capturing module 14 performs the posture estimation algorithm to the dynamic image of user 2, for example, the head portion image of the user 2, the image capturing module 14 can be applied to recognize the face features using algorithms or using software programs, so that face feature data of the user 2 can be generated. Specifically, by using algorithms or software programs to recognize the head portion image of the user 2, specific areas like eyebrows, facial features, and face shape, or other representative portions on the user's face can be distinguished, and several points are then applied to form the outline of these specific areas.

Next, these points are captured by the management module 11 as face feature points, and the face feature points are further combined with other contents of the head portion image to form the face feature data. Hence, the facial feature of the dynamic image can be obtained. The face feature points comprise several face position points. The face position points are predefined in face model data, and the alignment of the face position points forms the outline of the face model.

In this embodiment, the management module 11 stores plain body data. The plain body, in this embodiment, is defined as a model or an outline, of a human body or of a portion of the human body. For example, the plain body may be a head model or a whole body model as illustrated in this embodiment. The plain body data may comprise complete data regarding the head, the body, and the limbs. The front of the head is the face, and the face has the eyebrows, the eyes, the nose, the ears, and the mouth. The establishment of the plain body data may be achieved by obtaining human body information including facial data using the management module 11 and then applying 3D modeling techniques to the data.

The management module 11 may use the active appearance model (AAM) algorithm to analyze the head portion image to obtain 87 face feature points in total. These 87 face feature points have their registration numbers and correspond to the feature points of the feature regions of one group of plain body data. Hence, the face features of the plain body can be adjusted if needed.

In order to enhance the performance of the AAM algorithm, the AAM may be trained using one or more groups of reference images. Moreover, in order to further enhance the performance of the AAM algorithm, during capturing the face feature points, the model prediction and the process for the skin difference in YCbCr color space may be applied at the same time.

After the three-dimensional head portion image is generated, the management module 11 may additionally put pictures on the three-dimensional head portion image. Hence, the data content of the three-dimensional head portion image can have hair, eyeglasses, beards, or even other dress accessories. The items may be applied on the image by the aids of the positioning points. Specifically, in this embodiment, for example, the three-dimensional head portion image has positioning points corresponding to hair, and the chosen hair picture has positioning points corresponding to head portion image. Next, the management module 11 connects the corresponding points of the three-dimensional head portion image with the hair picture and then stores the result as a new three-dimensional head portion image. It is understood that, eyeglasses, beards, or other dress accessories may be applied on the image in a similar manner.

The system according to one or some embodiments of the present invention allows the user to have more fun in capturing the images and in the interaction with the system. According to user's personal preference, the user can wear the virtual object on the image or can interact with the virtual object.

For example, the management module 11 may store data regarding several three-dimensional articles, such as judge hat, judge cloth, superhero cloth, armor, clown hat, clown cloth, aviation helmet, and crown.

For example, an interaction between the virtual object and the user is, when the user's finger opens the mask of the aviation helmet, the mask displayed on the screen is opened.

For example, an interaction is, in the image, when the user's mouth is open, a rainbow can be produced from the user's mouth.

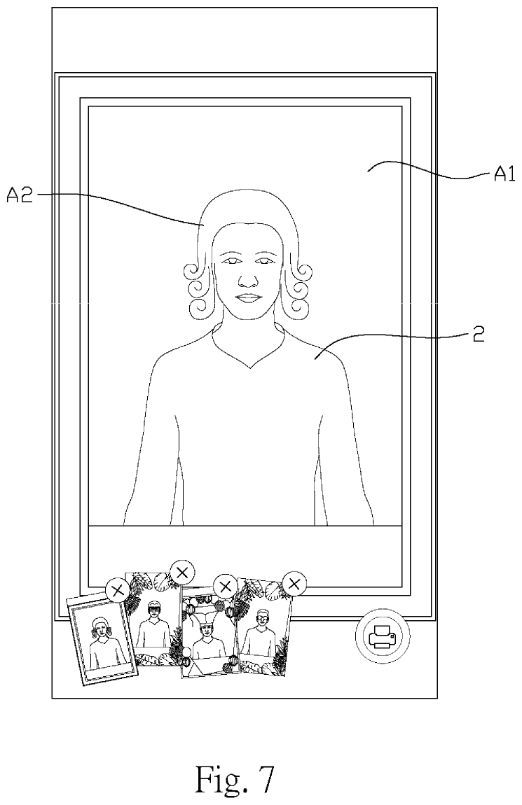

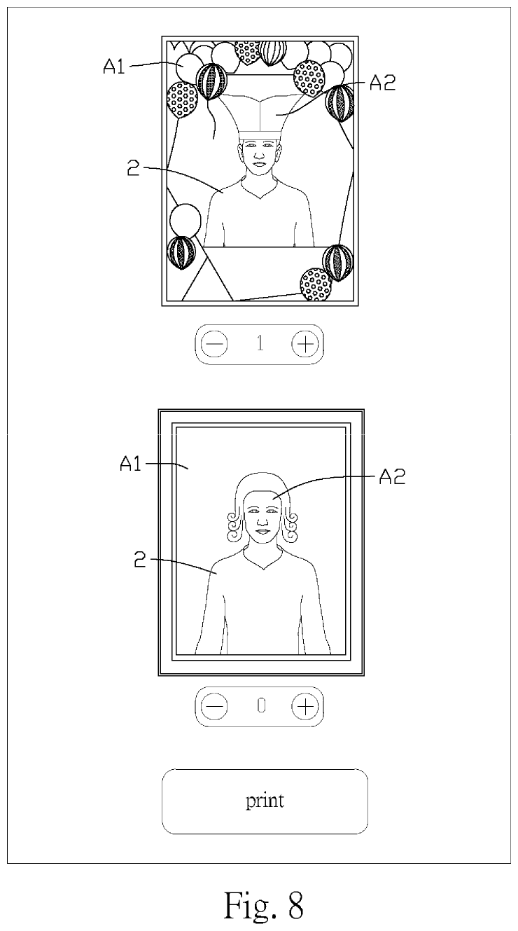

As shown in FIGS. 7 and 8, after the user 2 finishes the operation, the user 2 can transmit an output command to the management module 11 through the operation module 12 so as to make the image output module 15 output the dynamic virtual image. The image output module 15 outputs the dynamic virtual image as a photo, a puzzle, a postcard, a sticker, or a combination thereof, and embodiments of the present invention are not limited thereto.

In some embodiments, the system 1 comprises a transmission module 17, for example, a USB connector. Accordingly, a storage device of the user 2, for example, a flash disk can be mated with the USB connector. Therefore, the storage device can be signally connected to the transmission module 17 to receive the dynamic virtual image. Alternatively, the user 2 may have a device to receive the image data in the system 1 in wired or wireless manners. For example, the device may be, but not limited to, a smart phone, a tablet computer, a personal digital assistant, a camera (or video recorder) with network function, a wearable device, a smart electronic appliance, or a notebook computer. Moreover, the image data in the system 1 may be transmitted to a cloud server 18. The device of the user 2 is capable of downloading and executing a mobile application (APP), and then the data in the system 1 can be downloaded through the APP.

For example, the user's device may be a smart phone, and the smart phone can be communicationally connected to a server through networks using 3G or 4G mobile communication technologies or using Wi-Fi or other wireless communication technologies.

Moreover, in one embodiment, the system 1 may further comprise a cloud server 18. The cloud server 18 is adapted to receive the dynamic virtual image transmitted by the management module 11. Therefore, the dynamic virtual image stored in the cloud server 18 can be provided as a backup file, or the dynamic virtual image stored in the cloud server 18 can be downloaded by the user 2 through networks.

Furthermore, in one embodiment, the management module 11 may further request the display module 13 to display a link code (e.g., a QR code). Hence, a scan device, for example a smart phone, of the user 2 can scan the link code to download the dynamic virtual image from the cloud server 18.

The system 1 may further comprise a charge module 19 electrically connected to the management module 11. The charge module 19 is adapted to make payment receipt, so that the user is allowed to operate the operation module 12. The payment receipt is made with physical money, like cash or coins, or with virtual money, like using debit cards or credit cards.

Moreover, in one embodiment, the management module 11 further stores a plurality of multimedia images. The management module 11 requests the display module 13 to display the multi images in an idle state. For example, in the case that the system 1 is set in the airport, the display module 13 may display advertisements for commercial promotion purposes when the system 1 is free of operation. In some embodiments, the display module 13 may display the images regarding the operation of the system 1.

In one embodiment, the system further comprises a computation module electrically connected to the management module. The computation module is adapted to count physiological information of the user, a usage rate of the virtual scenario, a usage rate of the virtual object, or a combination thereof to generate statistics data, and the computation module is adapted to transmit the statistics data to the management module, and the statistics data can be stored in the management module. For the company, the statistics data is aim at the systematic internal data update and business communication promotion. The statistics data may record the gender of the user, the most used virtual scenario and the most used virtual object.

Based on the interactive augmented reality image capturing system according to one or some embodiments of the present invention, the user can have more virtual entertainments and more user-machine interaction experiences. According to user's personal preference, the user can wear the virtual object on the image or can interact with the virtual object, and the image can be outputted. As compared with the known image capturing system which is stationary and monotone, the interactive augmented reality image capturing system according to one or some embodiments of the present invention can be utilized widely and has a great commercial value.

Although the present invention has been described in considerable detail with reference to certain preferred embodiments thereof, the disclosure is not for limiting the scope of the invention. Persons having ordinary skill in the art may make various modifications and changes without departing from the scope. Therefore, the scope of the appended claims should not be limited to the description of the preferred embodiments described above.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An interactive augmented reality image capturing system comprising:
a management module comprising a control unit and a storage unit, wherein the storage unit stores at least one virtual scenario, at least one virtual object, or both the at least one virtual scenario and the at least one virtual object;
an operation module electrically connected to the management module, wherein the operation module is adapted to be operated by a user, so that the user is adapted to retrieve the at least one virtual scenario, the at least one virtual object, or both the at least one virtual scenario and the at least one virtual object;
a display module electrically connected to the management module; and
an image capturing module electrically connected to the management module, wherein the image capturing module comprises a sensing unit, the image capturing module captures a dynamic image of the user, the sensing unit detects three-dimensional dynamic information of the user and transmits the three-dimensional dynamic information to the management module;
wherein the management module receives the three-dimensional dynamic information and applies the at least one virtual scenario, the at least one virtual object, or both the at least one virtual scenario and the at least one virtual object on the dynamic image of the user to generate a dynamic virtual image, and the management module requests the display module to display the dynamic virtual image.

2. The interactive augmented reality image capturing system according to claim 1, further comprising an image output module electrically connected to the management module, wherein the user is adapted to operate the operation module to transmit an output command to the management module so as to make the image output module output the dynamic virtual image, wherein the image output module outputs the dynamic virtual image as a photo, a puzzle, a postcard, a sticker, or a combination thereof.

3. The interactive augmented reality image capturing system according to claim 1, further comprising a light module electrically connected to the management module for adjusting a light effect when the video recording unit captures the dynamic image of the user.

4. The interactive augmented reality image capturing system according to claim 1, further comprising a transmission module, wherein a storage device is adapted to be signally connected to the transmission module to receive the dynamic virtual image.

5. The interactive augmented reality image capturing system according to claim 1, further comprising a cloud server adapted to receive the dynamic virtual image transmitted by the management module.

6. The interactive augmented reality image capturing system according to claim 5, wherein the management module further requests the display module to display a link code, and a scan device is adapted to scan the link code to download the dynamic virtual image from the cloud server.

7. The interactive augmented reality image capturing system according to claim 1, further comprising a charge module electrically connected to the management module, wherein the charge module is adapted to make payment receipt, so that the user is allowed to operate the operation module, wherein the payment receipt is made with physical money or virtual money.

8. The interactive augmented reality image capturing system according to claim 1, wherein the management module further stores a plurality of multimedia images, and the management module requests the display module to display the multimedia images in an idle state.

9. The interactive augmented reality image capturing system according to claim 1, further comprising an image adjustment module electrically connected to the management module, wherein the user is adapted to operate the operation module so as to allow the management module to request the image adjustment module to adjust an image effect of the at least one virtual scenario, an image effect of the at least one virtual object, or both the image effect of the at least one virtual scenario and the at least one virtual object.

10. The interactive augmented reality image capturing system according to claim 1, further comprising a computation module electrically connected to the management module, wherein the computation module is adapted to count physiological information of the user, a usage rate of the at least one virtual scenario, a usage rate of the at least one virtual object, or a combination thereof to generate statistics data, and the computation module is adapted to transmit the statistics data to the management module.
